(19) United States
(12) Patent Application Publication
(10) Pub. No.: US 2020/0097903 A1
(43) Pub. Date: Mar. 26, 2020

(54) VIDEO RECEIPT SYSTEM

(71) Applicant: Happy Space Inc., Cincinnati, OH (US)

(72) Inventors: Benjamin Jung, Cincinnati, OH (US); Lagnajeet Das, Frankfurt am Main (DE); Varun Sharma, Cincinnati, OH (US)

(21) Appl. No.: 16/280,695

(22) Filed: Feb. 20, 2019

Related U.S. Application Data
(60) Provisional application No. 62/735,111, filed on Sep. 23, 2018.

(51) Int. Cl. G06Q 10/08; H04L 29/06; H04N 5/77; H04N 5/913

(52) U.S. Cl. CPC G06Q 10/0833; H04L 65/60; H04W 84/12; H04N 5/913; H04N 5/77

(57) ABSTRACT

A computer device for providing evidence of goods delivered and services performed. The computer device can include one or more processors and non-transitory computer-readable media storing computer-readable instructions executable by the one or more processors to perform operations. The operations can include storing video media recorded by a provider, the video media being at least a portion of a performance by a provider providing one of goods and services in the home of a customer, and delivering at least a portion of the video media to the customer. The delivered portion of the video media can be a receipt for the one of goods and services performed.

### REFERENCE TO RELATED APPLICATION

The present application is a U.S. non-provisional application that claims the priority benefit of U.S. provisional patent application Ser. No. 62/735,111, filed Sep. 23, 2018, and hereby incorporates the same application by reference in its entirety.

### TECHNICAL FIELD

Embodiments of the technology relate to recorded digital media, and uses therefor.

### BACKGROUND

A conventional receipt is a document that acknowledges a transaction in which a person has paid for and/or received goods or services. However, in the case of being absent of the exchange of goods and services, a conventional receipt cannot prove goods have been delivered or that services have been performed and executed to a given performance level.

Households today are becoming more integrated with connected service networks, and service providers are bringing these services directly in-home. Examples of such service networks and providers include electric utilities, cable providers, water utilities, and internet service providers. These services are common and in many cases necessary to live a comfortable life.

However, a gap in consumer need exists today for services that include transporting physical consumer goods or performing services directly inside a consumer's home at a specified space or location within the home. In general, consumers are reluctant to have a service provider inside their home, which can be considered both unsafe and an invasion of privacy. Instead, a household member acquires physical goods by shopping at a retail store or purchasing online with goods being dropped outside their door.

Further, there exists a gap in providers of goods and services in understanding and anticipating the needs of consumers. Because providers of goods and services are not inside a consumer's home, the provider cannot have any visual indication of the need for goods or services.

Moreover, there exists a gap in a way for consumers to have consumable goods as well as services replaced or performed, respectively, without the consumer needing to trigger a replacement.

Accordingly, there remains an unmet need for a system assuring consumers that goods and/or services are delivered inside a consumer's home.

Further, there remains an unmet need for providers of goods and/or services to collect in-home data in a cost-effective manner.

Additionally, there remains an unmet need for consumers to have consumable goods and repeat services performed without the consumer needing to initiate the transaction.

### SUMMARY

A computer device for providing evidence of goods delivered and services performed is disclosed. The computer device can include one or more processors and non-transitory computer-readable media storing computer-readable instructions executable by the one or more processors to perform operations. The operations can include storing video media recorded by a provider, the video media being at least a portion of a performance by a provider providing one of goods and services in the home of a customer, and delivering at least a portion of the video media to the customer. The delivered portion of the video media can be a receipt for the one of goods and services performed.

### BRIEF DESCRIPTION OF THE DRAWINGS

The present disclosure will be more readily understood from a detailed description of some example embodiments taken in conjunction with the following figures:

FIG. 1 depicts a schematic representation of a video receipt system of the present disclosure.

FIG. 2 depicts a schematic representation of an administrative component of the present disclosure.

FIG. 3 depicts a schematic representation of a portion of a video receipt system of the present disclosure.

FIG. 4 depicts a schematic representation of a web page of a video receipt system of the present disclosure.

FIG. 5 depicts a flow chart of a method of a video receipt system of the present disclosure.

FIG. 6 depicts an example device display of a video receipt system of the present disclosure.

FIG. 7 depicts an example device display of a video receipt system of the present disclosure.

FIG. 8 depicts a flow chart representation of a method of a video receipt system of the present disclosure.

FIG. 9 depicts a flow chart representation of a method of a video receipt system of the present disclosure.

FIG. 10 depicts a flow chart representation of a method of a video receipt system of the present disclosure.

### DETAILED DESCRIPTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment,” or “in an embodiment” in places throughout the specification are not necessarily all referring to the same embodiment. Furthermore, the particular features, structures or characteristics may be combined in any suitable manner in one or more embodiments.

Described herein are example embodiments of a video receipt system and its benefits. The examples discussed herein are examples only and are provided to assist in the explanation of the apparatuses, devices, systems and methods described herein. None of the features or components shown in the drawings or discussed below should be taken as mandatory for any specific implementation of any of these the apparatuses, devices, systems or methods unless specifically designated as mandatory. For ease of reading and clarity, certain components, modules, or methods may be described solely in connection with a specific figure. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

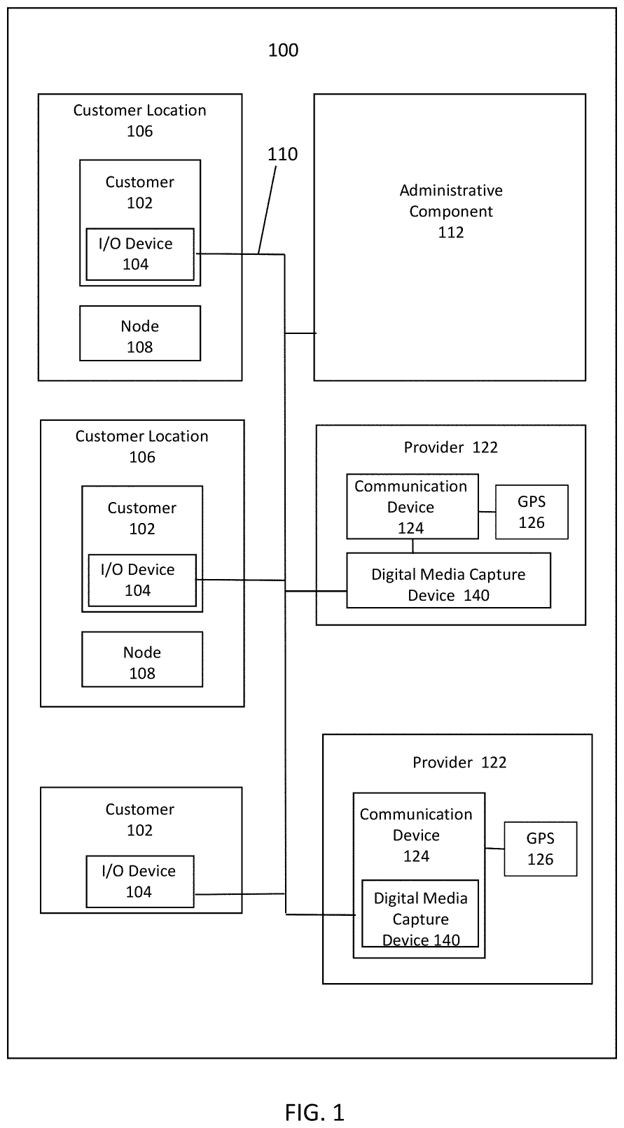

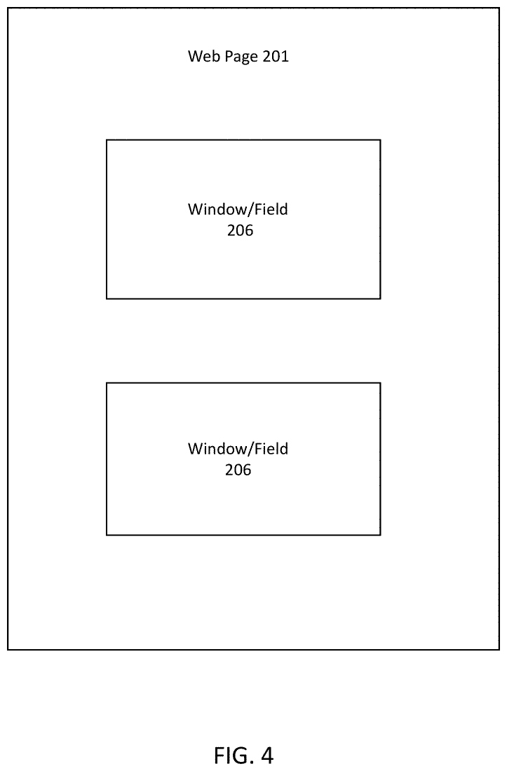

Referring to FIGS. 1-10, an embodiment of a video receipt system and related components is depicted schematically. The video receipt system 100 of the present invention preferably is a computer-aided system that operates to provide customers 102 with value added benefits from providers 122, such as businesses, in the form, for example, of video receipts for goods or services. As used herein the term “provider” refers to businesses, or personnel associated, e.g., employed by, businesses that use the video receipt system of the subject invention. Such providers can be related providers (businesses owned or operated by the same entity) or unrelated providers (businesses owned or operated by different entities). A provider can be termed an “assistant” as in one who assists in performing the delivery of a good or service.

The term “customer” or “customers” refer to individuals or companies that utilize a provider for the delivery of goods or services. A customer can be a client subscriber-user-viewer (SUV). That is, a customer can be a client of a provider, and the client-provider relationship can be such that the customer subscribes to a service of the provider, or uses the services of a provider, or views content of the provider.

Referring to FIG. 1, a schematic illustration of the methodology of a video receipt system 100 of the disclosure is shown comprising a plurality of customers 102 each having an input/output device 104. As shown, a customer 102 can be located within a customer location 106, such as a customer's home or place of business, or outside a customer location. Each customer location 106 can include one or more nodes 108 that operate to connect a customer 102 using the customer's input/output device 104. A node 108 can include, for example, a Wi-Fi connection. A customer input/output device can include tablets, mobile phones, smart phones, and other similar devices that can interact with the administrative component to register with the video receipt system or to enter or retrieve information, such as through a web page or an application (APP), or a social media system into the video receipt system.

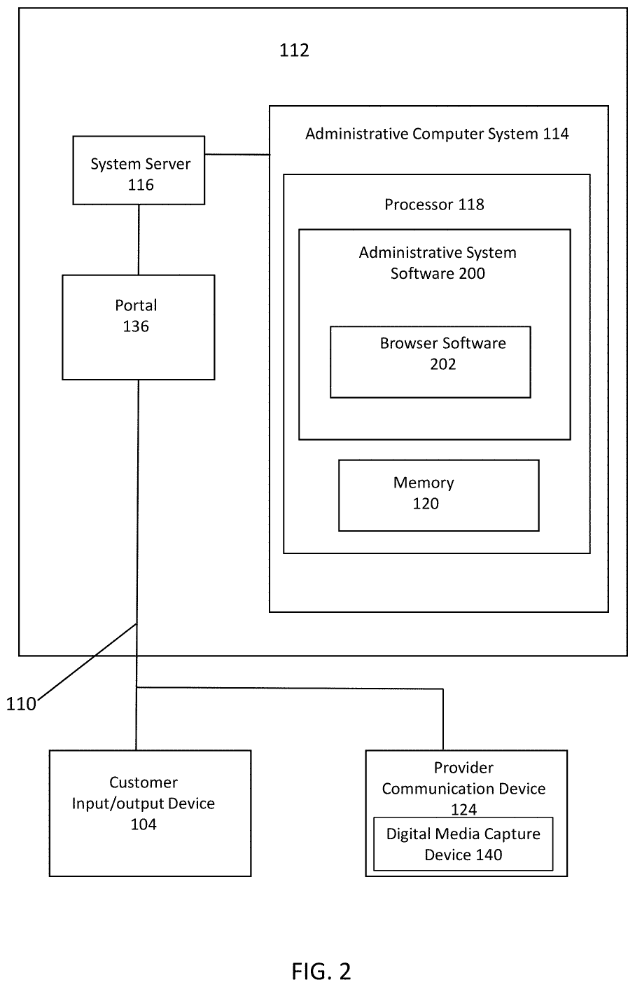

In an embodiment, as shown in FIGS. 1 and 2, an administrative component 112 can comprise an administrative computer system 114 for implementing and operating administrative system software 200 that can perform a method of the disclosure and which can be operated by a system administrator (not shown). The administrative computer system 114 is electrically linked to at least one system server 116 used to access and retrieve information with respect to the network system 110 as described herein below. The administrative computer system 114 can include a processor 118 for operating the administrative software system 200 and a memory 120 that can be non-transitory computer-readable media, and that can be electronically coupled to other devices, such as an input device, like a keypad, touch screen, or any other suitable input device (not shown) that can accept and store information, and one or more suitable output devices (not shown), such as a computer display, printer, and the like. Memory 120 can include database modules, including a customer database. It should be understood that the administrative computer system 114 can include any combination of the above components, or any number of different components, peripherals, and other devices. The administrative computer system 114 can operate under the control of an operating system, such as the WINDOWS operating system developed by Microsoft Corporation or the MACINTOSH operating system developed by Apple Computer Corporation. It should be understood, however, that other operating systems could be utilized to implement the administrative system software 200 of the video receipt system 100 of the present disclosure.

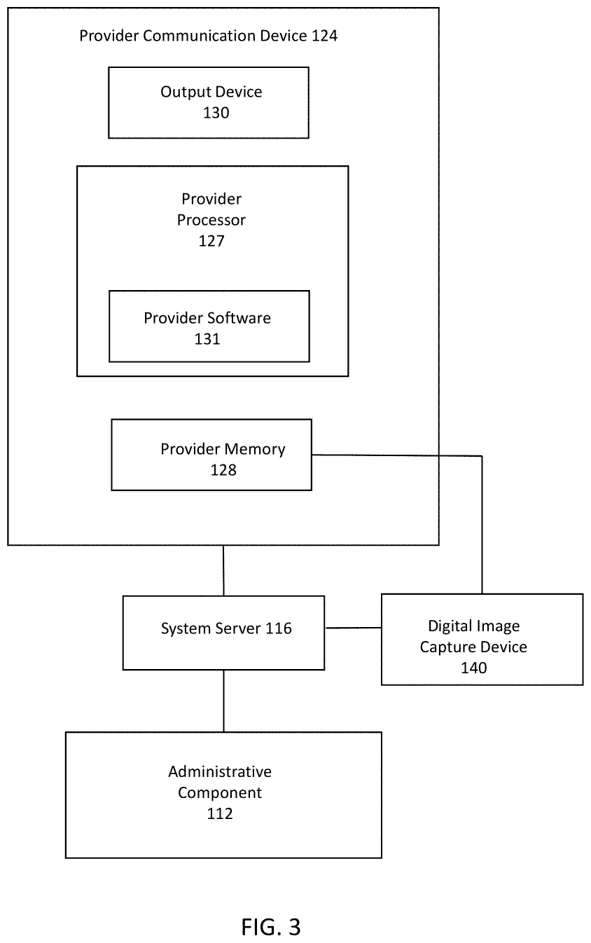

In an embodiment, as shown in FIGS. 1 and 3, an individual provider 122, such as a retail product or service provider, can have and operate a provider communication device 124. The provider communication device 124 can be a portable device such as a smartphone, tablet, or a computer, having a provider processor for implementing provider software 131 that cooperates with the administrative system software 200 to operate the video receipt system 100 and a provider memory 128, which can include one or more databases. The provider communication device can have a GPS receiver 126 to calculate, store, utilize and/or display a provider's geographic location. Each provider can have a digital media capture device 140, such as a digital camera or video camera, and which can transmit digital video and/or images to provider memory 128 or other system locations such as directly into the administrative computer system 114 via the system server 116, and which can be visualized on a suitable output device 130, such as a computer display, printer, and the like. The digital media capture device 140 can be integrated into the provider communication device, as depicted in FIG. 2, or it can be a separate device, as depicted in FIG. 3.

It should be understood that the provider communication device 124 can have an integrated image capture device, and can include any number of different components, peripherals, and other devices. In an embodiment, the provider communication device can be a smart phone. In an embodiment, the provider communication device 124 is configured such that it may communicate with the system server or other means, such as by a DSL modem or a cable modem, a T-1 line, ISDN line, or the like, for connecting to the Internet or other networking system for communication with the administrative component 112. The administrative system software 200 utilized by the administrative component 112 preferably includes conventional browser software 202 suitable for communication over the network system 110 such as the Internet, for cooperating with the customer input/output device 104 as well as the provider communication devices 124 to permit communication between the administrative component 112 and the customer input/output devices 104 and with the provider communication devices 124 to perform the method of the subject invention.

In an embodiment, the administrative system software 200 operates as an interactive, menu- and event-driven system that uses conventional type of prompt, dialog, and entry windows to guide a customer 102 to enter customer information, thereby providing an interactive communications interface for facilitating communications and information exchange between customers 102 and the video receipt system 100. As used herein, it should be understood that the term “software” refers to any form of programmed machine-readable language or instructions (e.g., object code) that, when loaded or otherwise installed, provides operating instructions to a machine capable of reading those instructions, such as a computer. The administrative system software 200 and browser software 202 of the present invention can be stored or reside on, as well as be loaded or installed from, one or more floppy disks, CD ROM disks, hard disks or any other form of suitable non-volatile electronic storage media. The system software 200 and browser software 202 can also be installed by downloading or other form of remote transmission, such as by using Local or Wide Area Network (LAN or WAN)-based, Internet-based, web-based or other remote downloading or transmission methods.

In an embodiment, the system software 200 cooperates with the customer's input/output device 104 to use conventional types of prompt, dialog, and entry windows to guide a customer 102 to enter customer information thereby providing an interactive communications interface for facilitating communications and information exchange between an individual customer 102 and the video receipt system 100.

As shown, the system server 116 of the administrative component 112 can operate to provide an interface between providers 122 using their provider communication devices 124 and the video receipt system 100, such as through the network system 110, such as the Internet, as well as providing the ability for providers 122 to register onto the system 100 to input, edit, store and retrieve existing video media or other content; obtain specific customer information and to actively manage a provider's account stored within the memory 120 of the administrative computer system 114, including in a customer database.

Referring to FIGS. 1-4, the administrative system software 200 of the administrative computer system 114 as shown operates to generate a portal access 136, such as in the form of an opening web page 201 having one or more windows or fields 206 for receiving customer information from a customer 102 and transmitting the customer information through the network system 110 to the administrative component 112 for storage in the provider memory 128. The opening web page 201 can also include one or more windows or fields 206 for allowing a provider 122 to review customer information stored in the provider memory 128 or to memory 120 of the administrative computer system 114. As shown, customer information inputted into the system 100 and stored in the memory 120 and/or memory 114, such as a data bank, preferably includes, but is not limited to, customer demographic information, specific customer data, preferably including, but not limited to, names, addresses, phone numbers, Email information, as well as other relevant information, and customer preferences.

In an embodiment, a customer 102 can first access the video receipt system 100 using the customer's input/output device 104 through the portal or access 136, such as through an interactive web page 201 (e.g. HTML page) generated by the administrative system software 200 and accessible through a network system 110 such as the Internet. The administrative system software 200 further operates to permit the customer 102 to register with the video receipt system 100, such as through the portal or access 136, and to perform the specific operations as more fully described below. The customer 102, using the customer's input/output device 104, can obtain access to the system server 116 such as through the Internet, to obtain access to the system's portal or access 136, such as the interactive web page 201, generated by and hosted by the system server 116.

In an embodiment, the system software 200 operates to direct the system server 116 to display an interactive web page 201 (e.g. HTML page) that provides the customer 102 with various options. In an embodiment of the disclosure the interactive web page 201 includes one or more windows or fields 206 for allowing a customer to register with the video receipt system 100 and to enter customer information into the video receipt system which is stored in the memory 120 of the administrative computer system 114. It should be understood that customer information can include specific customer data that comprises one or more of the following data: customer's address, phone number, email address, age, sex, education levels, working address, type of work, marital status, and number of children; and customer preferences that can include a customer's interests, hobbies, preferences (e.g., food preferences, restaurant preferences, store preferences, entertainment preferences, social interests,) and other pertinent information).

In an embodiment, the system software 200 operates to direct the system server 116 to display an interactive web page 201 (e.g. HTML page) that provides the customer 102 with various options, including to download or view a video receipt for goods or services received. For example, a provider such as a carpet cleaning service provider can enter a home and clean carpets per a customer's request. Before, during, or after performance of the services, the provider can, via the provider communication device 124 and or the digital media capture device 140, capture digital images, including in the form of video, of the customer location 106 and the performance of the services therein. Once the service task is completed, all or a portion of the digital images captured, including video, can be uploaded via network system 110 directly from the digital media capture device 140 via the system server 116 or directly to provider communication device memory 128. The digital images can be uploaded from the provider's communication device 124 to the administrative computer system 114, and stored in memory 120, as discussed above. Alternatively, the captured digital images can be connected via the provider's communication device 124 and transferred via the network system 110 to the administrative computer system 114. A customer 102 can subsequently utilize his or her customer input/output device 104, such as a smartphone or tablet, open the system web page 201 via the network system 110 to view, retrieve, and/or download all or a portion of the image capture stored on the administrative system, for example in provider memory 120. Alternatively, the captured images can be sent directly from the provider's communication device to the customer's input/output device 104 via the network system 110, which can include the internet, cloud computing, apps, and the like.

In an embodiment, a provider can be a network of employees or contractors. In an embodiment, the customer can be a person or other entity that utilizes the goods or services of a provider and can be considered to contract for, subscribe to, use, and/or view the goods and services of the provider.

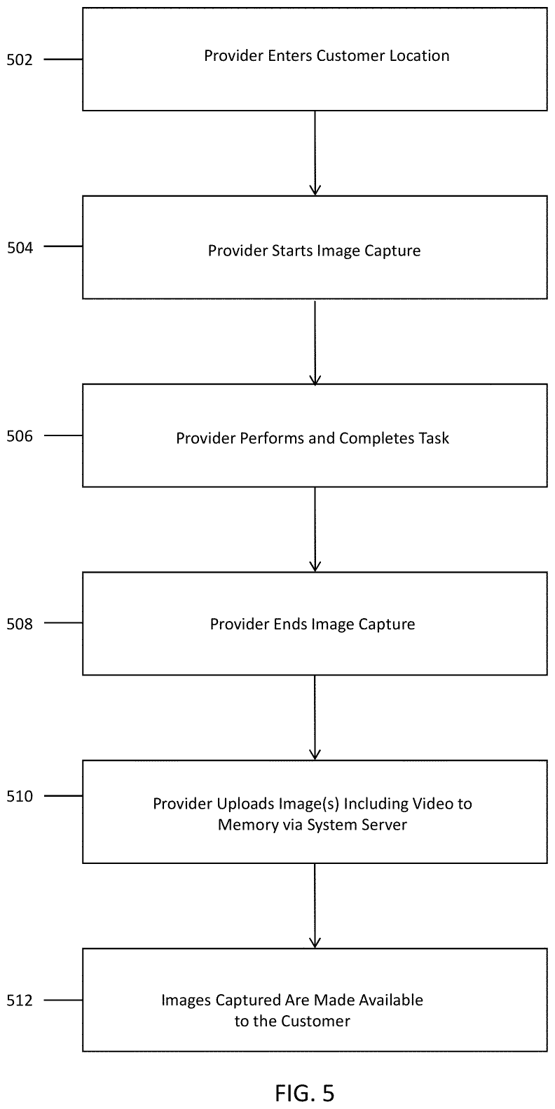

In an example workflow 500, as shown in FIG. 5, at 502 a provider, which can be a provider representative, such as an employee, enters a customer location, such as the customer's home or business, for a task which can be to deliver a good or provide a service. The location can be stored in the system by manual entry or by GPS location detection. At 504 the provider starts a video recorder prior to starting or during the delivery task. For example, the provider can start a video recorder inside the home before or during the delivery of services, the video recorder recording video of relevant aspects of the provider's activity inside the home. The video recording can also be started at any other time as determined by the provider, such as before entering the location of the customer. The video recorder can be a self-standing camera, such one or more video recorder(s) on a tripod(s) and positioned to capture the delivery of the services in the customer's location. In an embodiment, the video recorder can be worn on the person of the provider, such as, for example, in the form of a body camera. The body camera can be a BODYCAM® body-worn video camera by PRO-VISION®, or an Axon Body 2, or a Go Pro camera, a smartphone in camera mode, or a provider app utilizing a smartphone's camera. In embodiment, the body camera can be configured to be attached to the clothing of a provider, including a shirt, coat, hat or other headgear. In an embodiment, a combination of image capture devices can be utilized, including one or more stationary digital cameras, including video cameras, and/or one or more body cameras on one or more providers. As discussed, stationary digital cameras can be tripod-mounted, and can be, if desired, occasionally re-oriented.

A body camera can record the relevant movements and activities of the provider in the home as the provider performs the intended task, as well as the time, date, and location of the performance of task. In an embodiment location can be ascertained via GPS coordinate technology. At 506, the provider performs and completes the task. At 508 the provider stops the recording of the performance of the service. The video recording can be stopped at any time deemed sufficient to show that the task was performed, for example, to show that the service was performed completely. At 510 the video recording can be deposited in a location from which it can be made available to the customer. For example, at 510 the video recording can be uploaded to the memory of the computer system, as described above. At 512, the video recording can be made available to the customer. In an embodiment, the customer can access the administrative computer system and or view the video recording as a receipt for services performed. In an embodiment, the video recording can be sent, for example as an email attachment, to the customer.

Once the provider performs the task, such as delivery of the goods or services, the provider can end the video recording, and can upload all or a part of it to the administrative component 112 server 116 via the network system 110, and can be stored in memory 120. The video in whole or in part can be identified with an identification code and correlated to the provider and/or the customer in a provider database in memory 120 for future reference. The provider and/or the customer can use the identification code to access the video recording. Alternatively, the provider can send to the customer all or a portion of the video recording. The recording can be a video receipt and as such can be evidence of the delivery of the goods or services.

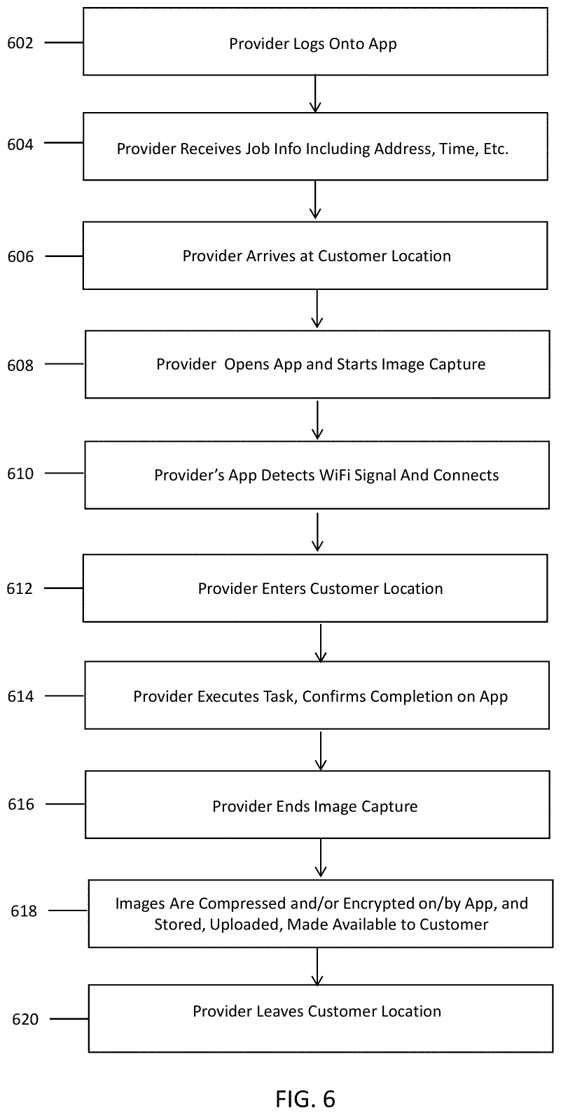

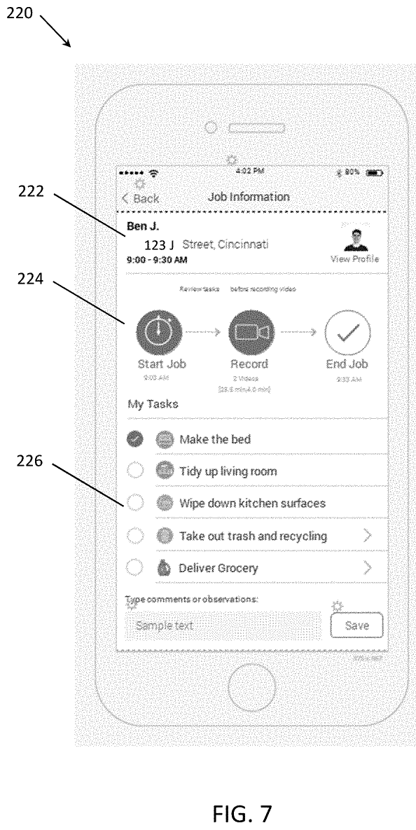

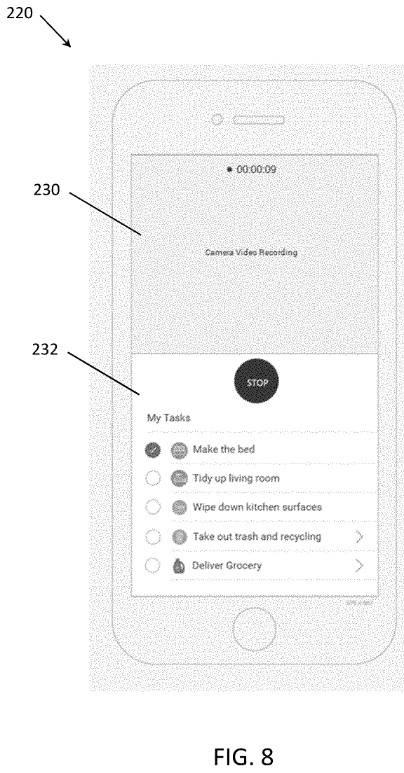

In an example workflow 600 showing a method and system of providing a service and utilizing a smartphone 220 (as shown in FIGS. 7 and 8), is shown with reference to flowchart 600 of FIG. 6. A smartphone 220 can be any of known mobile phones, tablets, or other devices, and can utilized apps as is known in the art, and which can be downloaded onto a smartphone by known methods, such as, for example, via Apple's App Store. Apps can have a user interface that can be accessed by voice or by touch. As described herein, an app can display “selectable features” that include buttons, radio buttons, images, and the like, that, upon selecting by voice or by touch cause the app to perform a task, such as go to another screen.

As shown in FIG. 6, at 602 a provider, which can be a provider representative, such as an employee, can log onto a mobile app on a smartphone 220 to receive information at 604 relating to jobs to perform. For example, as shown in FIG. 7, the app can display a field 222 that displays customer information, including, for example, the customer name, address, a customer profile, directions to the customer locations, and the like. A task field 226 can show tasks to perform, as well as selectable features to indicate tasks have been performed. If the provider chooses to perform the displayed services, he or she can interact with the job performance field 224 displayed on smartphone 220, which can include selectable features to start job, record job performance, and end job, for example.

At 606 a provider arrives at a customer location and can at 608, via the app, start image capture utilizing, for example, a camera of the digital media capture device 140, which can be displayed in real time as a camera recording at 230 of smartphone 220, and for which time (and date) can also be recorded. For example, in an embodiment, the provider can mount his or her mobile device on his or her body with the camera feature in video mode, and positioned it so as to capture the movements and activities of the provider at the customer location. In an embodiment, at 610 the provider can connect to the customer node 108, for example, Wi-Fi, such as from the customer's Wi-Fi router. That is, the customer location can have a Wi-Fi router emitting a Wi-Fi signal, and the provider's communication device can receive the customer's Wi-Fi signal. At 612 the provider can enter the customer location and at 614 the provider executes tasks associated with the job. The tasks can be performed in a prescribed order, such as an order shown in the job performance field 224. As each task is completed the provider can press, touch, or otherwise select the selectable feature related to that task to indicate the task is complete.

At 616 the provider stops image capture. In an embodiment, image capture can end before or after the provider departs the customer's location. At 618, the provider can compress the images, e.g., video footage, and the compressed video file can be stored in local app storage on the provider's mobile device, such as smartphone 224. Compressing video can create more storage in memory for more videos to be captured, so that a provider can execute more than one job utilizing the mobile app before exhausting memory space. In an embodiment, at 618 video can also be encrypted. Encryption ensures that viewing of the video can be limited to those authorized to view, and who have a decryption key, for example. In an embodiment, encryption can prevent the captured video from being viewed on the provider's mobile device, and prevents unauthorized sharing of captured video.

Also at 618, in an embodiment captured images, including compressed and/or encrypted video can be uploaded for viewing by the customer. The captured digital media can be stored as stored digital media, and can be delivered to the customer as delivered digital media. The delivered digital media can be selected from the stored digital media for customer convenience. For example, in an embodiment the entire stored digital media, such a video recording of the entire interaction of the provider in service of the customer can be delivered to the customer. In an embodiment, a subset of the entire image content, such as selected video clips of certain activities can be provided as delivered digital media to the customer. In an embodiment, still images can be provided, such as before and after images. That is, still images taken as still images (e.g, JPEG files) can be stored as part of the stored digital media and delivered as delivered media. Alternatively, still images can be taken (e.g., as a screen shot) from a video recording (e.g., an MP4 file) and provided as delivered media. In an embodiment, any and all of the various sets and subsets of images can be provided. For example, if a provider was to service a customer's home for cleaning, the provider could deliver a video file (e.g., an MP4 file) containing uncut video of the entire interaction. As well, the provider could deliver as delivered digital media video clips of certain of the activities, such as a video clip of emptying the trash, making the bed, and dusting shelves. In addition, the provider could provide still shots showing before and after pictures of the trash, the bed, and the shelves. Any or all of the various ways all or a portion of the stored digital media can be delivered as delivered digital media can be considered a receipt for services (or goods) delivered by the provider to the customer.

In an embodiment, video can be uploaded via network 110 to the administrative component 112 of the video receipt system. In an embodiment, video can be uploaded securely over the internet to cloud storage, for example, cloud storage that runs on Amazon Web Services (AWS) S3. In an embodiment, utilizing the customer's Wi-Fi facilitates faster uploading of video over the internet. In any uploading step, the video file for a particular job can be linked by the administrative computer system 114, for example, with a job ID, and stored in memory 120. Uploading of video over Wi-Fi or otherwise can be triggered automatically or manually. In an embodiment, upon complete upload of a video file for a customer and job, the original video file on the provider's smartphone 224 can be automatically deleted. This deletion step, and, if used, compression of the video file, can aid in preserving or creating more storage capacity on the provider's smartphone.

At 620, the provider leaves the customer location, and the performance of services can be complete. The provider can, for example, select “STOP” as shown at 232 of smartphone 220.

Once the performance of services is complete and the video file is uploaded, for example, to the cloud and/or stored in memory 114 of the administrative computer system 114, the administrative computer system 114 can send a URL, for example, by text or email, to the customer, the URL having linked the appropriate video file. The video file can also be posted on a secure web portal 136 that a customer can access at any time to view the appropriate video. The video supplied to the customer can be a receipt for services performed, and, in this manner, can be a video receipt.

The customer can also utilize web portal 136 to provide ratings and/or reviews for the services provided. In this manner, the video receipt system and method disclosed herein serves not only as a digital proof of services performed, but can also serve as an engaging medium to obtain customer feedback and improve the quality of the delivery of goods and services.

As discussed more fully below, the video receipt also helps the provider to proactively monitor quality, drive consistent standards, and train service providers. Furthermore, the videos can be processed in bulk by image recognition algorithms to generate insights relating to customer consumption patterns and consumer habits, which, in turn, can be utilized for a system and method of smart replenishment of household consumables.

Thus, in an embodiment of the present disclosure, the image collection, including video recording by a provider in the customer location can be aggregated over time and the aggregated video footage can be analyzed to extract usage of goods within the customer location, and/or behavior of the customer in the customer location. That is, the images collected over time, including video recordings over time, can serve as a data source to providers of goods and services, such that providers of goods and services can objectively and subjectively track various behaviors, both of the provider as well as the customer. For example, in an embodiment, video recordings, both individually and aggregated, can be used to track the consumption of consumer goods. A provider, as he or she goes about her business in providing tasks can also be collecting data, including passively, in the form of image capture showing the status of various goods, and the need for replacement. For example, a provider doing house cleaning can, in the course of cleaning a kitchen, for example, collect video recording information of under-sink, pantry, or closet cleaning supplies. The video recording and information gathered from the data collected thereon can then be used to provide to the customer goods or services seen as needing replacement.

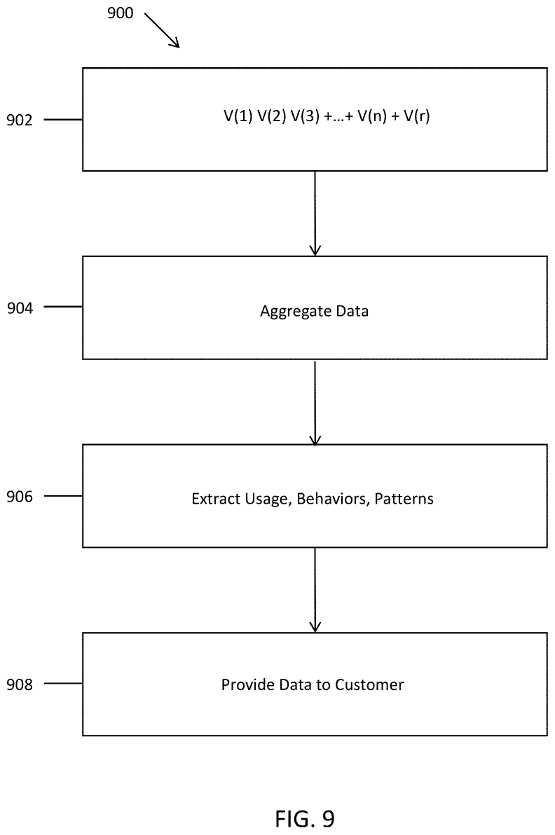

Thus, with respect to the flow chart of FIG. 9, in an embodiment the video receipt system of the present disclosure 900 can, at 902, collect n recorded videos V(n) as well as at least r individual real time videos V, i.e., V(r), such as by being stored in system memory 120. At 904 the collected videos can be aggregated and can be stored as individual videos or as a single video. At 906 the aggregated video recordings can be analyzed to extract data usage levels, behaviors, and/or patterns from the consumer location. At 908 the extracted data can then be utilized to inform the customer, reorder goods, reschedule services, and/or combinations thereof. In an embodiment, the video is made available to the customer, and the customer can make re-order decisions based thereon.

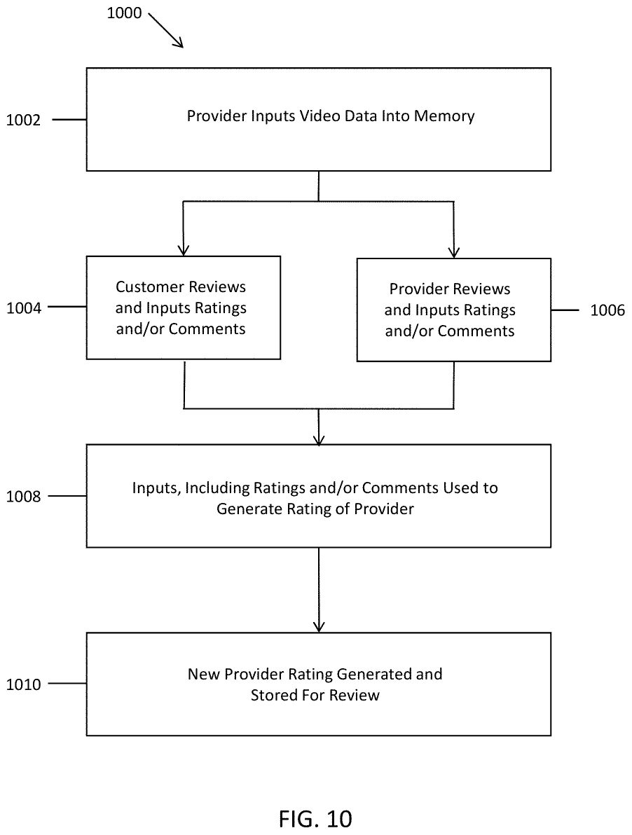

In another embodiment, video recordings, either singly or in combination, can be utilized to objectively or subjectively rate a provider in delivery of the task(s), and the ratings, in turn, can be used to adjust provider performance. For example, as indicated in the flow chart of FIG. 10, a provider employee can input, e.g., upload a video recording to the administrative component 112 of video receipt system 100. The uploaded video recording can be reviewed by one or both of the customer and the provider employee's management or other evaluator. The provider employee's performance can be rated by any rating system deemed appropriate, and an algorithm can weigh the customer's and/or the provider employee's management inputs and, optionally, any historical ratings of the provider employee, and output a new rating. The new rating can be stored and retrieved for review by, for example, the provider employee and/or his or her management.

Thus, with respect to the flow chart of FIG. 10, in an embodiment the video receipt system of the present disclosure 1000 can, at 1002, have inputted by the provider, e.g., upload, a video recording to the computer system memory 120. At 1004 a customer can review the video recording, and can rate the performance of services, and/or comment on the performance of the service. Rating and/or commenting can be by known methods, such as by online survey tools like Survey Monkey, or the like. Reviews and ratings process will most likely be our own built system part of 112 Likewise, at 1006 a third party, such as the employer of the provider who performed the task, can review the video recording, and can rate the performance of services, and/or comment on the performance of the service. In an embodiment, either of the customer review at 1004 or the third party review at 1006 can be optional. At 1008 the ratings and comments of the customer and/or the third party can be assessed and used to formulate a new provider rating. The formulation can also take into account the historical ratings for the subject provider. In an embodiment, the new provider ratings can be subjectively determined by a person or entity reviewing ratings and comments from step 1004 and/or 1006. In an embodiment, the ratings are formulated by an algorithm programmed with predetermined value inputs as desired by the end user of the ratings. At 1010 the new provider ratings can be made available for the subject provider to review.

The foregoing description of embodiments and examples has been presented for purposes of illustration and description. It is not intended to be exhaustive or limiting to the forms described. Numerous modifications are possible in light of the above teachings. Some of those modifications have been discussed, and others will be understood by those skilled in the art. The embodiments were chosen and described in order to best illustrate principles of various embodiments as are suited to particular uses contemplated. The scope is, of course, not limited to the examples set forth herein, but can be employed in any number of applications and equivalent devices by those of ordinary skill in the art. Rather it is hereby intended the scope of the invention to be defined by the claims appended hereto.

We claim:

1. A computer device for providing evidence of goods delivered and services performed, the computer device comprising:
a. one or more processors; and
b. non-transitory computer-readable memory storing computer-readable instructions, the instructions being executable by the one or more processors to perform operations comprising:
i. storing video media recorded by a provider, the video media being at least a portion of a performance by a provider;
ii. delivering at least a portion of the video media to the customer; and
wherein the at least a portion of the video media is a receipt for the one of goods and services performed.

2. The computer device of claim 1, wherein the operations further comprise compressing the video media.

3. The computer device of claim 1, wherein the operations further comprise encrypting the video media.

4. The computer device of claim 1, wherein the operations further comprise compressing and encrypting the video media.

5. The computer device of claim 1, wherein the operations further comprise compressing and encrypting the video media and uploading at least a portion of compressed, encrypted video media to memory.

6. The computer device of claim 5, wherein the memory is selected from the group consisting of the cloud and device memory in a computer system of the computer device.

7. The computer device of claim 6, wherein the operations further comprise aggregating video media with one or more second video media and extracting from the aggregated video media a determination of usage of goods in the home of the customer.

8. A digital receipt system for providing a receipt for services provided by a provider for a customer in need of the services, the digital receipt system comprising:
a. an input/output device connected to a network system, the input/output device related to a customer, the customer agreeing to have the provider provide a service at a customer location;
b. a communication device of a provider connected to the network system and a digital media capture device;
c. one or more processors connected to a system server, the system server being connected by a portal to the network system;
d. non-transitory computer-readable media storing computer-readable instructions executable by the one or more processors to perform operations comprising:
i. storing digital media recorded by a provider on the digital media capture device, a portion of stored digital media comprising a video recording of at least a portion of a performance by a provider;
ii. delivering the portion of stored digital media as a portion of delivered digital media to the customer, the portion of delivered digital media comprising at least one still image capture from the video recording; and
wherein the a delivered portion of the digital media is a receipt for the one of goods and services performed.

9. The digital receipt system of claim 8, wherein the operations further comprise compressing the digital media.

10. The digital receipt system of claim 8, wherein the operations further comprise encrypting the digital media.

11. The digital receipt system of claim 8, wherein the operations further comprise compressing and encrypting the digital media.

12. The digital receipt system of claim 8, wherein the operations further comprise compressing and encrypting the digital media and uploading a portion of compressed, encrypted digital media to memory.

13. The digital receipt system of claim 8, wherein the customer location comprises a Wi-Fi router emitting a Wi-Fi signal and the provider's communication device is connected to the receive the Wi-Fi signal, and further wherein the operations further comprise compressing and encrypting the digital media and uploading a portion of compressed, encrypted video media to memory via the Wi-Fi signal of the Wi-Fi router.

14. A method for providing a receipt for the performance of a service, the method comprising the steps of:
providing a customer in need of a service;
providing a location of the customer in need of the service;
providing a provider of the service;
providing a provider communication device, the provider communication device comprising a video camera;
providing a computer system, the computer system comprising non-transitory computer-readable media;
performing, by the provider of the service, the service at the location;
recording, by the video camera, video media of the performance of the service;
storing at least a portion of the video media in the provider communication device;
uploading to the computer system the at least a portion of the video media;
storing the at least a portion of the video media in the transitory computer-readable media; and
delivering to the customer the at least a portion of the video media.

15. The method of claim 14, further comprising the step of compressing the at least a portion of the video media.

16. The method of claim 14, further comprising the step of encrypting the at least a portion of the video media.

17. The method of claim 14, further comprising providing a Wi-Fi signal at the location of the customer, and the step of receiving the Wi-Fi signal by the provider communication device.

18. The method of claim 14, further comprising the step of compressing and encrypting the video media and uploading the compressed, encrypted video media to memory.

19. The method of claim 14, wherein the provider communication device runs an app, the app having selectable features selected from the group of selectable features to start performance of the service, selectable features to indicate the execution of performance of the service, and selectable features to indicate the end of performance of the service.

20. The method of claim 14, further comprising the step of aggregating the video media with one or more second video media and extracting from the aggregated video media usage of goods in the home of the customer.
